(19) United States
(12) Patent Application Publication
(10) Pub. No.: US 2019/0385100 A1
(43) Pub. Date: Dec. 19, 2019

(54) System And Method For Predicting Organizational Outcomes

(71) Applicant: Massachusetts Institute of Technology, Cambridge, MA (US)

(72) Inventors: Tauhid Rashed Zaman, Boston, MA (US); David Hunter, Cambridge, MA (US); Ajay Saini, Shrewsbury, MA (US)

(21) Appl. No.: 16/437,082

(22) Filed: Jun. 11, 2019

Related U.S. Application Data
(60) Provisional application No. 62/684,470, filed on Jun. 13, 2018.

(51) Int. Cl. G06Q 10/06; G06F 17/16; G06N 7/00

(52) U.S. Cl. CPC G06Q 10/067; G06N 7/00; G06F 17/16; G06Q 10/06375

(57) ABSTRACT

A system for modeling an entity includes a prediction module configured to identify one of a plurality of entities using a set of criteria filters to construct a model for the entity with model features built from data about the entity. The prediction module computes a diffusion model coefficient σ based on a diffusion parameter vector γ, and a drift model coefficient μ based on a drift parameter vector β. The module computes a predicted entity success probability and a success interval confidence interval. A portfolio selection module is configured to receive a score measuring success for the plurality of entities based on the model, order the scores in a rank order, and form a portfolio from top n scoring entities. A prediction interpretation module receives parameter vectors β and γ and entity model coefficients μ and σ and uses distributions of β and γ to correlate entity features with success prediction.

### CROSS-REFERENCE TO RELATED APPLICATIONS

This application claims the benefit of U.S. Provisional Patent Application Ser. No. 62/684,470, filed Jun. 13, 2018, entitled “Picking Winners: A Data-Driven Approach to Evaluating Startups And Making Venture Capital Investments,” which is incorporated by reference herein in its entirety.

### FIELD OF THE INVENTION

The present invention relates to modeling of systems, and more particularly is related to outcome predictions based on an organizational model.

### BACKGROUND OF THE INVENTION

A model of an entity or organization may be used to understand and/or predict the trajectory of the entity/organization. For example, an important problem in entrepreneurship is evaluating the quality of a startup company. This problem is challenging for a variety of reasons. First, most companies are not successful so there is a relatively small pool available discern patterns of success. Second, there is relatively little data available regarding successful companies at the times when they are founded as startup companies, typically only basic non-predictive information about the company's founders, the sector or market in which it operates, and the identity of initial investors. This data may not be sufficient to measure the quality of a startup company quality or to predict whether or not it will succeed. Third, it has been unclear how to model the evolution of a startup company and how to use this model to measure its quality. Fourth, a principled approach is needed to test the validity of any startup company model or quality measure. Therefore, there is a need in the industry to address one or more of these shortcomings.

### SUMMARY OF THE INVENTION

Embodiments of the present invention provide a system and method for predicting organizational outcomes. Briefly described, the present invention is directed to modeling an entity with a prediction module configured to identify one of a plurality of entities using a set of criteria filters to construct a model for the entity with model features built from data about the entity. The prediction module computes a diffusion model coefficient σ based on a diffusion parameter vector γ, and a drift model coefficient μ based on a drift parameter vector β. The module computes a predicted entity success probability and confidence interval. A portfolio selection module is configured to receive a score measuring success for the plurality of entities based on the model, order the scores in a rank order, and form a portfolio from top n scoring entities.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a high level block diagram of an exemplary system for predicting organizational outcomes.

FIG. 2 is a flowchart of an exemplary embodiment of a method for the prediction module of FIG. 1.

FIG. 3 is a flowchart of an exemplary embodiment of a method for the portfolio selection module of FIG. 1.

FIG. 4 is a flowchart of an exemplary embodiment of a method for the prediction interpretation module of FIG. 1.

FIG. 5 is a schematic diagram illustrating an example of a system for executing functionality of the present invention.

FIG. 6 is a screenshot of an entity search feature in an exemplary web application of the present invention.

FIG. 7 is a screenshot of an entity information page in the exemplary web application.

FIG. 8 is a screenshot of a portfolio-building page in the exemplary web application.

### DETAILED DESCRIPTION

The following definitions are useful for interpreting terms applied to features of the embodiments disclosed herein, and are meant only to define elements within the disclosure.

As used within, an entity generally refers to the subject of a model, for example an organization such as a startup company.

As used within this disclosure, an “exit” generally refers to a successful outcome for a modeled entity. For example, in the model of a startup company an exit indicates the startup company is they are either acquired or has an initial public offering (IPO). Exiting is also referred to herein as “winning,” and an entity that exits is referred to herein as a “winner.” The process of identifying a winning entity is referred to as “picking a winner.”

As used herein, a “portfolio” refers to a selected subset of entities within a larger population of entities. A portfolio of entities containing at least one winning entity is referred to herein as a “winning portfolio.”

As used herein, an “anomalous feature” refers to a feature of a model that is likely to indicate whether or not the modeled entity will succeed.

As used herein, a “score” refers to a numeric value indicating the probability the entity will have a successful exit.

Reference will now be made in detail to embodiments of the present invention, examples of which are illustrated in the accompanying drawings. Wherever possible, the same reference numbers are used in the drawings and the description to refer to the same or like parts.

The embodiments disclosed herein are related to modeling organization/entities to provide predictions regarding the likelihood of success of the organizations/entities. Throughout this document, the embodiments use startup companies as exemplary organizations/entities, and whether a startup company was acquired or had an initial public offering (IPO) as measures of success of a startup company. However, the modeling and prediction techniques described in these embodiments are not limited to startup companies, and may be employed with other types of organization/entities, for example non-commercial organizations/entities.

The embodiments described below generally take an operational perspective for validating a model for startup company quality. Such a model may be used, for example, by venture capital firms or other investors to build portfolios of startup companies. Therefore, the operational value of a model is its ability to produce successful portfolios.

In addition to building portfolios of startup companies, the systems/methods illustrated in the embodiments may be used to model a variety of problems which have a low probability, high reward structure. For instance, most new drugs developed by pharmaceutical companies fail. However, with a small probability some of the drugs are successful. These winning drugs provide an immense profit for the company, as well as a large benefit to society. Having one winning drug can be enough for a company to be successful. For another example, consider a studio that has to select a set of movies to produce. The studio is considered successful if it can produce one blockbuster. In these examples, one approach to the problem is to select a portfolio of items (drugs, movies, startup companies) to maximize the probability that at least one of them exceeds a given performance threshold, or wins.

In general, the exemplary system and method embodiments quantify the quality of a startup company. The embodiments incorporate a dataset for over twenty-four thousand companies including funding round dates, investors, industry, customers, competitors, and detailed professional and educational history of the founders. However, twenty-four thousand is just an example, and different embodiments may incorporate a data of more or fewer entities.

The embodiments incorporate a predictive model for the evolution of funding rounds for startup companies and describe a startup company using a Brownian motion with a company dependent drift and diffusion. The first passage times of the Brownian motion at different motion levels correspond to the startup company receiving a new round of funding, and the highest motion level corresponds to the company exiting. Parameters of the model may be estimated using a Bayesian approach, facilitating statistical analysis of features that impact company success and how this impact varies by industry. The embodiments further employ the model to picking winners' portfolios.

An exemplary application for the embodiments includes a web platform which provides a user interface for data analysis, model estimation, and portfolio building results publicly available to venture capital investors.

It is useful to demark growth of a modeled entity according to its acquisition of resources. For example, a startup company typically receives resources (funding) in a sequence of rounds. The initial funding is known as the seed round. After this, the company can receive funding in a series of ‘alphabet rounds’ which are called series A, series B, etc. The alphabet rounds typically do not go beyond series F. A company can reach an exit, which is when a startup company is either acquired or has an IPO.

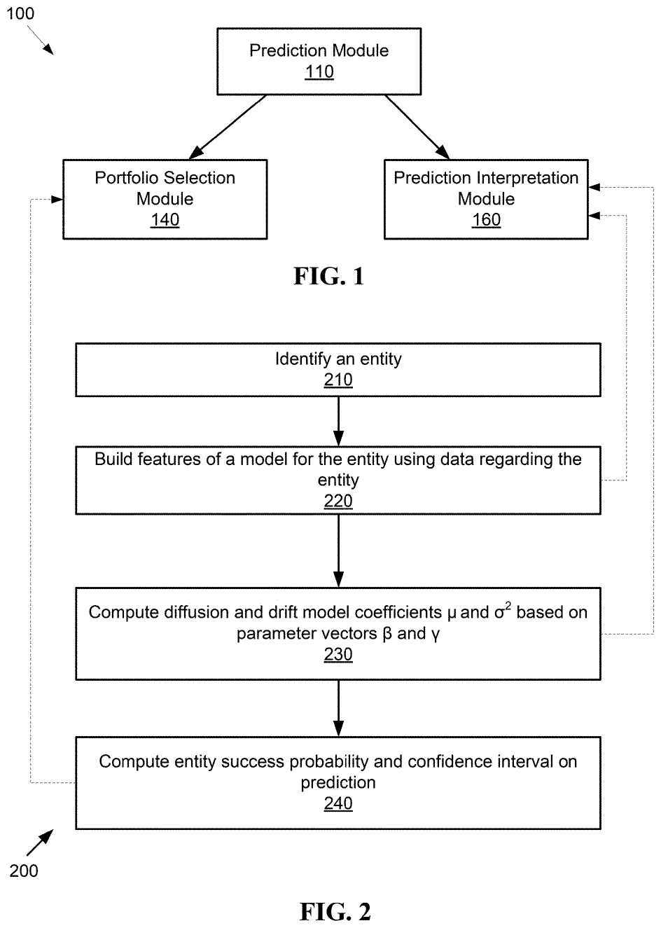

FIG. 1 is a high level block diagram of an exemplary embodiment of a system 100 for predicting organizational outcomes. The system includes a prediction module 110, a portfolio selection model 140, and a prediction interpretation module 160. The prediction module 110 uses an entity model (described further below) to compare the exit probabilities of entities. The portfolio selection model 140 uses predictions from the prediction module on a batch of entities to select a portfolio from a larger set of entities. The prediction interpretation module 160 analyzes the specific features about an entity that resulted in the probability (prediction) computed via the model.

FIG. 2 is a high-level flowchart of an exemplary embodiment of a method 200 for the prediction module 110 of FIG. 1. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

An entity is identified, as shown by block 210. For example, a user of the system 100 may select a startup company from a plurality of startup entities using a set of criteria filters. The prediction module 110 (FIG. 1) constructs a model for the entity by building features of the model for the entity using data regarding the entity. Diffusion σ and drift μ model coefficients are computed based on parameter vectors γ and β respectively, as shown by block 230 and described in further detail below. The entity success probability and confidence interval on prediction are computed, as shown by block 240.

The following describes in detail using data for model features as per block 220 (FIG. 2), using the example of selecting a startup company as an entity. The model features may range from simple features such as a sector of the startup company sector, to more complex features relating to the similarity of the academic and occupational backgrounds of founders of the startup company. The model features for a startup company may be constructed using only information known at the time the company received its first funding round, referred to herein as the baseline date of the company.

For the example of a startup company, a significant portion of model features relate to the sector that a startup company was involved in. Sector labels for a company may be obtained from an online database, for example, Crunchbase. A company may belong to multiple sectors. While Crunchbase has informative labels for many different features, under the first embodiment binary indicators for a subset of features were chosen. Preferably a wide-variety of sectors may be included in the model, ranging, for example from fashion to artificial intelligence. An example listing of sectors may include: 3d printing, advertising, analytics, animation, apps, artificial intelligence, automotive, autonomous vehicles, big data, bioinformatics, biotechnology, bitcoin, business intelligence, cloud computing, computer, computer vision, dating, developer APIs, e-commerce, e-learning, edtech, education, Facebook, fantasy sports, fashion, fintech, finance, financial services, fitness, gpu, hardware, health care, health diagnostics, hospital, insurance, internet, internet of things, iOS, lifestyle, logistics, machine learning, medical, medical device, messaging, mobile, nanotechnology, network security, open source, personal health, pet, photo sharing, renewable energy, ride sharing, robotics, search engine, social media, social network, software, solar, sports, transportation, video games, virtual reality, and virtualization.

Additional model features relate to resources available to the entity, in particular for the example of a startup company, investor data. Again using data from Crunchbase, a dynamic network of investors and companies may be constructed, such that there is a node for every investor and company that exists at the particular time of interest, and there is an edge connecting an investor to a company if the investor has participated in a funding round for that company before a given time of interest. The network is used to construct a feature that goes into the model for both training and prediction, taking qualitative data about companies and their investors and producing a number to represent that data for the model. For example, the network may be a “bipartite graph” which is used in different fields such as graph theory and network analysis.

For this embodiment, the network used available data, here roughly 83,000 companies and 48,000 investors. It should be noted the 83,000 companies refers to all the companies where information was obtained from Crunchbase, while the previously mentioned 24,000 companies were used to both train and test the model. Features for an individual company may be derived based on this dynamic network at the time when the company had its first funding round. Data for companies without reliable time information for their seed or series A funding rounds was omitted. Therefore, for a particular company the dynamic network of investors was considered at the time of the earliest of these rounds. The dynamic network is used to construct a feature called the investor neighborhood. In an investor neighborhood, for a company i having an earliest funding date of tᵢ, the value of this feature is the number of startup companies in existence before year tᵢ that share at least one investor in common with company i. This value may be normalized by the total number of companies founded before tᵢ. This feature measures the relative reach of the company's investors.

Another feature that may be derived from this dynamic network is the maximum IPO fraction. For each initial investor j connected to company i, fⱼ is defined as the fraction of companies connected to j at tᵢ that also had an IPO before tᵢ. The feature value is then the maximum value of fⱼ amongst all initial investors in i. A related feature is called maximum acquisition fraction. This feature is identical to maximum IPO fraction, except the fraction of companies that were acquired is used rather than the fraction that had an IPO. Both maximum IPO fraction and maximum acquisition fraction are measures of the success rate of a company's initial investors.

A dynamic network of companies may be constructed where edges between companies signify that they are competitors. Specifically, a directed edge eᵢⱼ exists between company i with baseline date tᵢ and company j with baseline date tⱼ<tᵢ if at least one of company i or j listed the other as a competitor, for example on Crunchbase, or if both companies i and j listed the same company k with baseline date tₖ<tᵢ as a customer on Crunchbase.

Using this network, features for competitors A, competitors B, competitors C, competitors D, competitors E, competitors F, competitors acquisition, and competitors IPO are defined. Each of these features for a company i is calculated as the number of edges eᵢⱼ pointing to companies j whose highest round at time tᵢ is the specified round for the feature divided by the out-degree of i. Additionally, for every company i a feature is included called “had competitor info” which is a binary indicator for whether the company self-reported competitors, for example on Crunchbase. “Had competitor info” is included as a feature because it is a psychological factor whether or not founders were willing to self-report their competitors which influences whether or not the founders are able to run a successful company.

Leadership features for founders and executives of a company may be derived from databases such as Crunchbase and LinkedIn to measure the experience, education, and ability of the company's leadership. Data is used to consider the employees, executives, and advisors of the company of interest. Indicator features may be considered such as Job IPO, Job Acquired, Executive IPO, Executive Acquired, Advisory IPO, and Advisory Acquired which indicate if someone affiliated with the company has been part of a previous company that was either acquired or reached an IPO before the date of interest. In particular, for the Job variables people who work for the company but are not executives or advisors are considered, for the Executive variables people who are labeled as an executive in the company are considered, and for the Advisor variables people who are labeled as advisors but not executives are considered.

Also considered are features based on LinkedIn data, such as “previous founder” which indicates the fraction of the leadership that had previously founded a company before the baseline date of the given company. The number of companies affiliated is also used, which is the average number of companies each leadership member was affiliated with before joining the given company. An additional pair of experience features is work overlap mean and work overlap standard deviation. To construct these features, the Jaccard index of previous companies is calculated for each pair of leadership members. The Jaccard index is defined as the intersection of previous companies divided by the union of previous companies for the pair of members. The mean and standard deviation of these values is taken across all pairs of leadership members to obtain the two features.

An exemplary education feature is “from top school” which is the fraction of leadership members that went to a top school. Other features indicate the highest education level of the leadership, measured by degree received. These features are high school, bachelors, master's, and Ph.D. For each degree, the fraction of leadership members whose maximum education level equals that degree is measured to obtain the feature value.

Other features may be based on the education and academic major overlap. These features are education overlap mean, education standard deviation, major overlap mean, and major standard deviation. For each one the relevant Jaccard index over all pairs of leadership members, and then take the mean and standard deviation is calculated. For education, the Jaccard index is taken with respect to the schools attended by each member and for major, the Jaccard index is taken with respect to the academic majors of each member.

Another, more complex feature is major company similarity which captures the similarity of the academic major of the leadership and the company sector. A semantic similarity score is created between each member's major and the sector of their company. For example, the Palmer-Wu similarity score, which measures the similarity of words in a semantic network based on the distances to their most common ancestor and to the root may be used. This score is zero for totally different words and one for equivalent words. The Palmer-Wu major-sector similarity score is averaged for each member to obtain the feature value.

Another feature is leadership age. This is the average age of all leadership members when the company was founded. To estimate the age it is assumed assume that each member is eighteen years old when finishing high-school and twenty two years old when finishing undergraduate education. With this assumption, the age of a member is set to be equal to 22+ company founding year less the year member received/would have received his undergraduate degree.

In some instances the available data may be incomplete. In such cases values for the missing data may be imputed. M dimensional feature vectors for N companies are computed, creating a M by N matrix with missing values. To impute these missing values, a matrix completion algorithm may be used, for example, Soft-Impute which achieves the imputation by performing a low-rank approximation to the feature matrix using nuclear norm regularization. Soft-Impute uses a regularization parameter and a convergence threshold. To obtain the regularization parameter, all missing values may be replaced with zero and the singular values of the resulting matrix are calculated. For example, the regularization parameter may be set to be the maximum singular value of this filled in matrix divided by 100 and the convergence threshold set to 0.001. The imputation calculation may be applied with these parameters to the incomplete feature matrix to fill in the missing values. This imputed feature matrix may be used for all subsequent model fitting and prediction tasks. Note that this process is preferably repeated for each considered training set and testing set to ensure causality is not violated.

Under the first embodiment, an exemplary stochastic model is used to model how a company reaches different funding rounds and the relevant probability calculations needed to construct portfolios. The exemplary model captures the temporal evolution of the funding rounds through the use of a Brownian motion process.

The model assumes a company has a latent value process X(t) which is a Brownian motion with time-dependent drift μ(t) and diffusion coefficient σ²(t). The latent value process X(t) is initiated with value 0 when the company receives its first funding round. The set of possible funding rounds that used is R={Seed, A, B, C, D, E, F, Exit}. Each funding round is denoted by an index l between 0 and 7 (inclusive), with l=0 corresponding to seed funding, l=1 corresponding to series A funding, and so forth. The final level is l=7, which corresponds to exiting. For each funding round l a level hₗ is greater than equal to 0, and the levels are ordered such that hₗ₋₁ is less than hₗ. The spacing of these levels may be linear, but other spacings may be chosen. In the exemplary model, hₗ=Δl for some Δ>0. A company receives round 1 of funding when X(t) hits hₗ for the first time, and this time is denoted as tₗ. Therefore, the time to receive a new round of funding is the first passage time of a Brownian motion.

The first passage time distribution for a Brownian motion with arbitrary time-varying drift and diffusion terms is difficult to solve. In particular, one must solve the Fokker-Planck equation with an appropriate boundary condition. However, the Fokker-Planck equation may be solved exactly with the appropriate boundary condition when the ratio of the drift to the diffusion is constant in time. Therefore, it is assumed that the drift and diffusion terms are of the form μ(t)=μ₀f(t) and σ²(t)=σ₀²f(t), where μ₀, σ₀²(t), and f(t) are appropriately chosen. These assumptions result in the following standard result for the first passage time distribution.

For a Brownian motion X(t) with drift μ(t)=μ₀f(t), and diffusion σ²(t)=σ₀²f(t), and initial value X(v₀)=0, let V_{α}=inf_{t>v0} {X(t)≥α} denote the first passage time to level α>0 after time v₀. Then the probability density function (PDF) of V_{α} is

$${f}_{0} ( v ; {v}_{0} , μ ( t ) , σ ( t ) , α ) = \frac{{σ}^{2} ( v ) α}{\sqrt{16 π {S}^{3}}} {e}^{- \frac{{( α - M )}^{2}}{4 S}} \qquad ( Eq . 1 )$$

and the cumulative distribution (CDF) function is

$${F}_{0} ( v ; {v}_{0} , μ ( t ) , σ ( t ) , α ) = Φ ( \frac{M - α}{\sqrt{2 S}} ) + exp \{ \frac{M α}{S} \} Φ ( \frac{- ( M + α )}{\sqrt{2 S}} ) \\ where M = {\int }_{{v}_{0}}^{v} μ ( s ) ds , \\ S = \frac{1}{2} {\int }_{{v}_{0}}^{v} {σ}^{2} ( s ) ds , \\ and Φ ( \cdot ) is the standard normal CDF . \qquad ( Eq . 2 )$$

As described above, companies which succeed typically take a constant amount of time to reach each successive funding round, which may motivate companies having a positive and constant drift coefficient for some time period. Additionally, many companies succeed in reaching early funding rounds somewhat quickly, but then they fail to ever reach an exit. This motivates these companies to have a drift that decreases in time. Lastly, as time gets very large, a company that has not achieved an exit will most likely not achieve a new funding round. This translates to a latent value process moving very little as time gets large, which can be modeled by having the drift and diffusion terms moving toward zero. To incorporate these properties, the following model is used for the drift and diffusion coefficients:

$$μ ( t ) = {μ}_{0} ( 1 \{ t \leq v \} + {e}^{- \frac{t - v}{τ}} 1 \{ t > v \} ) \\ {σ}^{2} ( t ) = {σ}_{0}^{2} ( 1 \{ t \leq v \} + {e}^{- \frac{t - v}{τ}} 1 \{ t > v \} ) \qquad ( Eqs . 3 , 4 )$$

where μ₀, σ₀², ν, and τ are appropriately chosen based on the data. Under this model, the drift and diffusion are constant for a time ν after which they decay exponentially fast with time constant τ. Under the exemplary model, every company has the same ν and τ. However, each company may have a different drift term μ₀ and diffusion term σ₀ that may be determined by its features. For a company i define a feature vector xᵢ a member of R^{M}, a drift μᵢ₀, and a diffusion σ²ᵢ₀. A parameter vector β_{y} is a member of R^{M} for year y. A company i that has baseline year (earliest funding year) y has μᵢ₀=β^{T}_{y} xᵢ. Furthermore,

β_{y+1}=β_{y}+ϵ (Eq. 5)

where ϵ=[ϵₗ, . . . , ϵ_{M}] and ϵᵢ is normally distributed with zero mean and variance δ²ᵢ for i between 1 and M inclusive. This time varying coefficient model allows for capturing any dynamics in the environment which could increase or decrease the importance of a feature. For instance, consider a feature which is whether or not the company is in a certain sector. The coefficient for this feature may change over time if the market size for this sector changes. Additionally, this time varying model allows for capturing uncertainty in future values of the drift weights (described below) to construct the joint distribution of first passage times for the companies.

Additionally, the volatility of the funding rounds data may vary substantially between sectors. For instance, companies in some sectors may frequently achieve early funding rounds very quickly, but then fail to ever reach an exit. To model this phenomenon, heteroskedasticity is introduced into the model and allow each company to have its own diffusion coefficient. Here, another parameter vector δ (a member of R^{M}) is defined, where σ²ᵢ₀+(g(γ^{T}xᵢ))², and g(z) may be, for example, the positive region of the hyperbola with asymptotes at z=0 and g(z)=z. Other models are possible for the drift and diffusion terms.

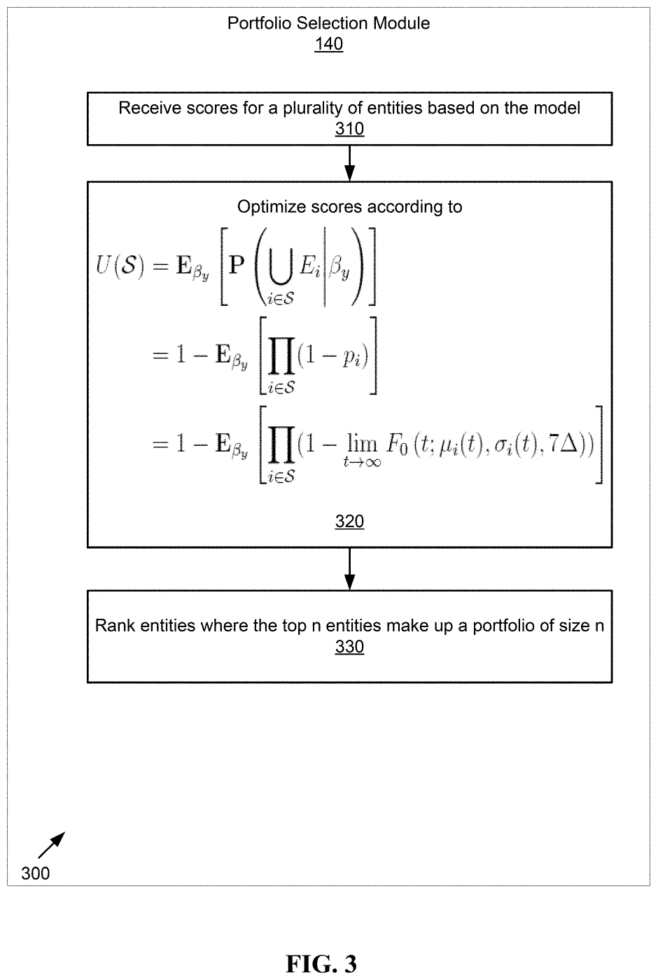

FIG. 3 is a high-level flowchart of an exemplary embodiment of a method 300 for the portfolio selection module 140 of FIG. 1. The scores are optimized as per Eq. 8 (see below), as shown by block 320. The top n scoring entities are ranked in a portfolio of size n, as shown by block 330.

The portfolio selection module 140 evaluates the quality of startup companies via the Brownian model described above. Eᵢ is defined as the event that company i reaches an exit sometime in the future. The portfolio selection module 140 builds a portfolio of k companies to maximize the probability that at least one company exits. To do this, portfolio selection module 140 evaluates the exit probability. For a set of companies S,

U(S)=P(∪_{i∈S}Eᵢ) (Eq. 6)

When all Eᵢ are independent and objective function is given as,

$$\begin{matrix}U ( S ) = 1 - P ( {⋂}_{i ∈ S} {E}_{i}^{c} ) \\ = 1 - {\prod }_{i ∈ S} ( 1 - {p}_{i} )\end{matrix} \qquad ( Eq . 7 )$$

where pᵢ=P(E) and Eᵢ^{c} denotes the complement of E.

The portfolio selection module may be set to use different sets of algorithms corresponding to different assumptions. For example, one algorithm may assume the companies are independent and another assumes the companies are correlated. Eq. 8 (below) is the equation used for selecting the “independent companies portfolio” and Eq. 9 (below) is used for selecting the “correlated companies portfolio”. Adding drift to the beta values corresponds to the correlated companies portfolio selection algorithm. In general, a correlated companies portfolio may result in selecting portfolios with more company exits.

For example, when the portfolio selection module 140 assumes that the performance of the companies is independent, the portfolio selection module 140 therefore calculates pᵢ=P(Eᵢ) for each company i that is a member of S to construct the portfolio, where pᵢ is the probability that the Brownian motion of the company hits level 7Δ in finite time. The portfolio selection module 140 assumes a given μᵢ(t) and & σᵢ(t) for company i. Then, from Eq. 2, the exit probability becomes

$${p}_{i} = {lim}_{t \to ∞} {F}_{0} ( t ; 0 , {μ}_{i} ( t ) , {σ}_{i} ( t ) , 7 Δ ) \qquad ( Eq . 8 )$$

Since future values of β_{y} are uncertain, there is corresponding uncertainty in the drift which results in the companies no longer being independent. So here, the portfolio selection module assumes the companies and their corresponding success probabilities are correlated (i.e. not independent). To see why this is the case, assume the parameter vector β_{y-1}. This will be the situation when training on past data up to year y−1 for a portfolio for companies founded in year y. Therefore, the portfolio selection module 140 needs to determine β_{y}=[β_{y1}, β_{y2}, . . . β_{yM}]. Since βyi is normally distributed with mean β_{y-1}, i and standard deviation δᵢ, this results in random drift coefficients for all companies founded in year y. The portfolio selection module 140 does not know the exact value of the company drifts, but the portfolio selection module 140 does know that they will all be affected the same way by the actual realization of β_{y}. This is how the uncertainty creates a correlation between the companies. To calculate U(S), the portfolio selection module 140 averages over the uncertainty in β_{y}. Combining Eq. 7 and Eq. 8 results in

$$\begin{matrix}U ( S ) = {E}_{{β}_{y}} [ P ( {⋃}_{i ∈ S} {E}_{i} \vert {β}_{y} ) ] \\ = 1 - {E}_{{β}_{y}} [ {\prod }_{i ∈ S} ( 1 - {p}_{i} ) ] \\ = 1 - {E}_{{β}_{y}} [ {\prod }_{i ∈ S} ( 1 - {lim}_{t \to ∞} {F}_{0} ( t ; {μ}_{i} ( t ) , {σ}_{i} ( t ) , 7 Δ ) ) ]\end{matrix} \qquad ( Eq . 9 )$$

Because β_{y} is jointly normal and it is simple to evaluate F₀(⋅), this expectation can be determined using Monte Carlo integration. For the Brownian model, because the large number of startup companies the portfolio selection module 140 creates the portfolio using a greedy approach, which is computationally feasible because in practice the portfolio will not be very large (typical venture capital firms manage no more than a few hundred companies), simplifying the evaluation U(S) for a set S.

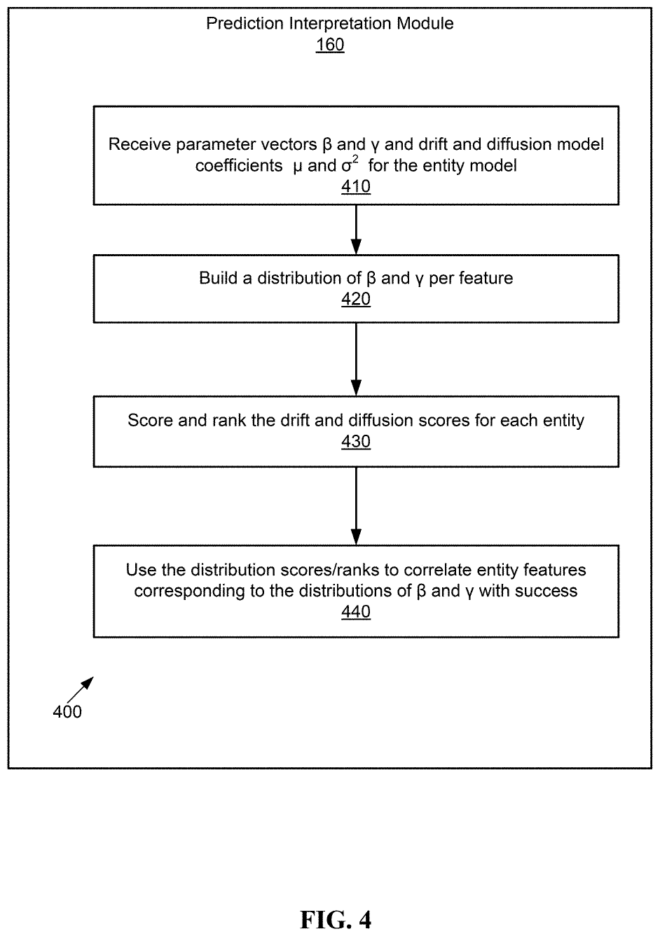

FIG. 4 is a high-level flowchart of an exemplary embodiment of a method 400 for the prediction interpretation module 160 of FIG. 1. The prediction interpretation module 160 receives drift and diffusion model coefficients μ and σ² respectively in addition to parameter vectors β and γ for the entity model, as shown by block 410. The prediction interpretation module 160 builds a distribution of β and γ per feature, as shown by block 420. A score and rank for the diffusion and drift scores is determined for each entity, as shown by block 430. The distribution scores/ranks are used to correlate entity features corresponding to the distributions of β and γ with success, as shown by block 440. An exemplary application of this method is described below.

The exemplary model uses the years 2011 and 2012 because it gives a sufficient amount of time for the companies to achieve an exit. For each test year, the companies with baseline year (earliest funding year) equal to that year were defined as the test set, and all other companies used in model estimation as the training set. The models were estimated on companies with baseline year before the test year. The features used to calculate the exit probabilities of the test companies were built using only data that would have been available at the time of the companies' earliest funding round. This way, the only data used would have been available to an early investor. The following greedy portfolio construction method was used:

$${f}_{i} = arg {max}_{f ∈ [ m ] / {S}_{G}^{i - 1}} U ( {S}_{G}^{i - 1} ⋃ f ) - U ( {S}_{G}^{i - 1} ) , 1 \leq i \leq k . \qquad ( Eq . 10 )$$

where S_{G}=(f₁, f₂, . . . , fₖ) is the greedy solution of the optimization problem. The greedy solution is an ordered set, with item f₁ being added on the ith step of the greedy optimization. Sⁱ_{G}=(f₁, f₂, . . . , fᵢ) is the solution obtained after the ith item is added to S_{G}, with S⁰_{G}=0.

The portfolios were built once assuming companies are dependent and again assuming that they are independent. The difference in the two assumptions is that uncertainty in the drift parameters is jointly averaged over companies in the dependent case. For the dependent assumption, all companies are jointly averaged and used to optimize Eq. 9. For the independent assumption, Eq. 8 is used to average over the uncertainty for each company individually, and then the resulting exit probabilities are used to construct the portfolio. The averaging is done using Monte Carlo integration.

Specifically, for every β sample, a random draw is generated from a normal distribution for each element of the β vector for the testing year, with mean given by β₂₀₁₀ or β₂₀₁₁ (depending on the testing year) and standard deviation given by the corresponding element in δ. The relevant function is averaged over these random variates. The model was benchmarked against an ordered logistic regression model using the model features and labels corresponding to the largest round that a company achieved before the test year. Similarly, portfolios were constructed for four Bayesian models with a maximum of 30 companies.

One exemplary practical application of the embodiments described above includes, but is not limited to a web platform which gives users access to both model estimation and portfolio selection results. While the target audience of the web platform is venture capital investors, the web platform is accessible to anyone who is curious about startups and what influences their success.

The platform has three primary features. The first feature is a company search and analysis feature which allows users to access data for all companies in a collected set of companies and view information about the company such as which of its features are anomalous, what the model estimated the various β (mean) and γ (variance) coefficients to be, and what the funding round time series of the company looks like. This feature has applications in allowing venture capital investors to understand which factors are most indicative of the success of a company from the present data modeling perspective. The second feature is a portfolio building tool which allows investors to use the embodiment model predictions and portfolio building approach to build and evaluate portfolios of their own. This feature has applications in both allowing investors to prioritize companies to talk to and in training new investors in evaluating startup portfolios. Lastly, a user profile feature is described which allows investors to keep track of companies they are interested in and portfolios they have created.

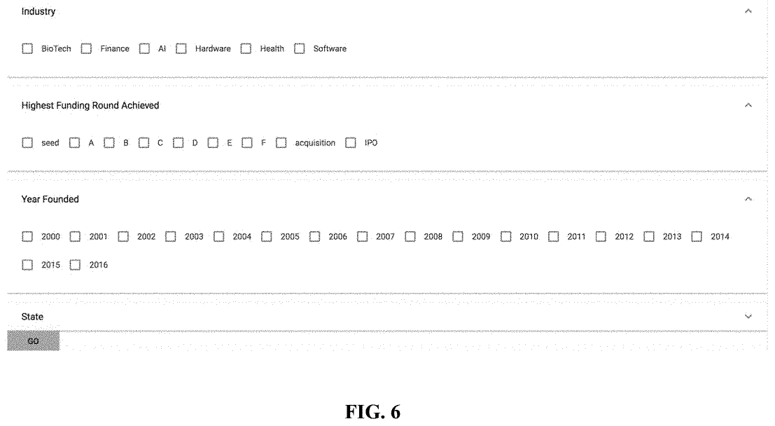

The user of the web application may access the data in two primary ways. The first method is by typing in the name of a company. The second is through an advanced search feature where users can select attributes of industry, highest funding round achieved, year founded, and state located, and receive a list of all companies in the database that match the selected attributes. The feature is shown in FIG. 6.

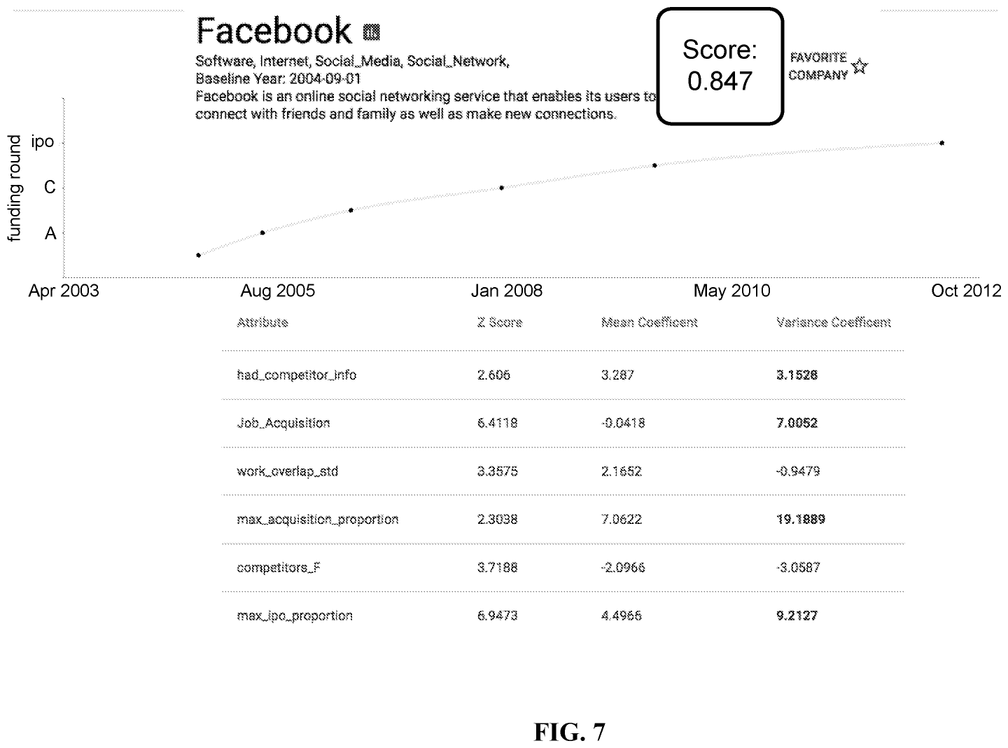

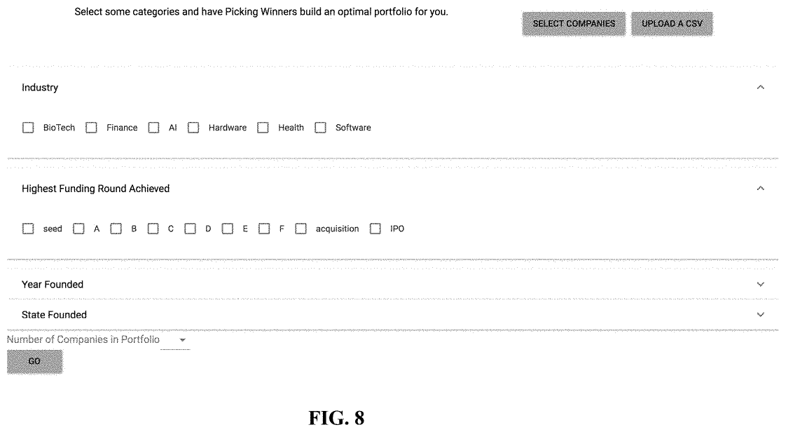

When a user selects a company through either of the search features, they are redirected to a page about the company. The page contains basic information about the company such as the industries, baseline year (year of first funding), and a description. The page also displays a graph of the funding rounds of the company in addition to the mean exit probability of the company as calculated by the model (shown as the “Score” field). Lastly, the page shows a table of z-scores of the features computed from the company data and the sample mean of the β (mean coefficient) and γ (variance coefficient) values. These values are shown for anomalous features of the company, defined as having a z-score greater than 2 or less than −2. These values give an investor insight into what features for a particular company are both different from most other companies and also most indicative of company success according to the model. An example of a company page is shown in FIG. 7 for the company Facebook.

The application provides three tools through which users can use the estimation results of the model to build venture capital portfolios. The first is a portfolio from categories tool which is similar to the company advanced search feature in that users can select attributes from the four categories industry, highest funding round achieved, year founded, and state located. However, this time the user also enters a portfolio size and is given an optimal portfolio chosen from the set of companies matching the selected attributes using the correlated portfolio selection algorithm detailed above. The second is a portfolio from names tool which allows users to enter the names of companies they would like to be in a portfolio and then have the model return the list of companies ordered by their mean exit probability.

The last tool is a portfolio from csv upload tool which allows users to upload a comma separated values (csv) file containing the names of companies they would like to be in a portfolio. From there, the model returns a list of the companies ordered by their mean exit probability. A picture of the portfolio-building page is shown in FIG. 9. Note that the portfolio from names tool can be accessed by clicking “Select Companies” and the portfolio from csv upload tool can be accessed by clicking “Upload a CSV”.

The systems and methods described above have a number of applications beyond building venture capital portfolios. For example, one common problem in the venture world is narrowing down a very large list of companies into a more manageable number to have in-person meetings with. For example, a portfolio from the csv upload tool allows investors to upload a list of such companies and then get a prioritized list of companies ordered by how likely they are to succeed. Furthermore, the portfolio selection tools can be used as training tools for new investors. Here, new investors have the ability to compare some of their chosen portfolios against those chosen by the model in addition to having the model evaluate the quality of some of their chosen portfolios by ordering the companies they chose based on the model's predicted mean exit probability. In other embodiments, the system may use different models with different exits, for example, modelling the likely acceptance/success of new pharmaceuticals.

While the above embodiment includes specific equations for one exemplary model, a person having skill in the art will recognize that other models fit into the general framework described here, for example, other models which takes in the mentioned data and output a quality score.

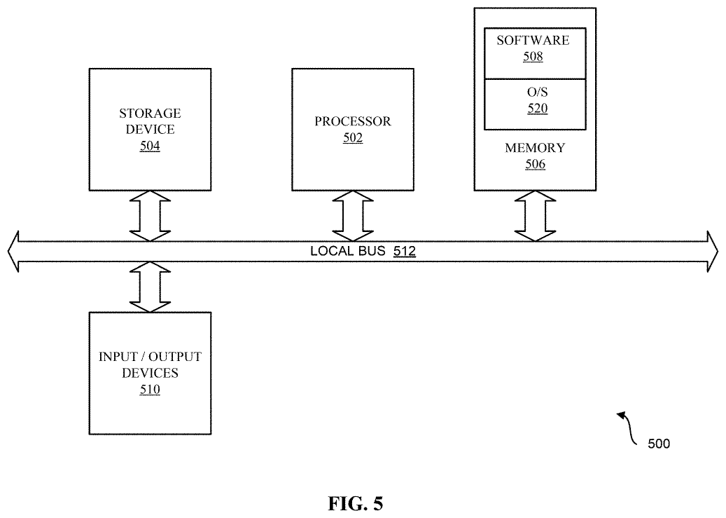

As previously mentioned, the present system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It will be apparent to those skilled in the art that various modifications and variations can be made to the structure of the present invention without departing from the scope or spirit of the invention. For example, the methods/systems described above may be used to predict success of newly developed drugs. In view of the foregoing, it is intended that the present invention cover modifications and variations of this invention provided they fall within the scope of the following claims and their equivalents.

What is claimed is:

1. A computer implemented method of estimating an attribute of an entity, the method of estimating based on a set of data, the set comprising resource data, an industry sector of the entity, investor data, a competing entity data, personnel data, and estimated missing data, the method comprising the steps of:
identifying an entity from a plurality of entities using a set of criteria filters;
constructing a model for the entity by building features of the model for the entity using data regarding the entity;
computing a diffusion model coefficient σ based on a diffusion parameter vector γ;
computing a drift model coefficient μ based on a drift parameter vector β; and
computing a predicted entity success probability and a success probability confidence interval.

2. The method of claim 1, further comprising the steps of:
receiving a score for the plurality of entities based on the model;
ordering the scores in a rank order; and
forming a portfolio from top n scoring entities,
wherein the score comprises a measure of success for the entity.

3. The method of claim 2, wherein forming the portfolio includes an assumption that the plurality of entities are correlated.

4. The method of claim 2, wherein forming the portfolio includes an assumption that the plurality of entities are independent.

5. The method of claim 1, further comprising the steps of:
receiving a diffusion σ and a diffusion parameter vector γ for the model;
receiving a drift model coefficient μ and a drift parameter vector β the model;
for a plurality of features, building a distribution of β and γ for each feature;
scoring and ranking diffusion and drift scores for the entity based on the distribution; and
using the scores and ranks to correlate an entity feature corresponding to the distributions of β and γ with a success for the entity.

6. The method of claim 1, further comprising the steps of:
imputing missing data regarding the entity, further comprising:
forming an M by N matrix of M dimensional feature vectors for N entities; and
performing a low-rank approximation to the feature matrix using nuclear norm regularization.

7. The method of claim 6, wherein performing the low-rank approximation further comprises using a regularization parameter and a convergence threshold.

8. The method of claim 7, wherein using the regularization parameter comprises replacing a missing value with a zero and calculating a singular value of the resulting matrix.

9. A system for modeling an entity, the system comprising a computer to evaluate a set of data, comprising:
a prediction module, configured to perform steps comprising:
identifying an entity from a plurality of entities using a set of criteria filters;
constructing a model for the entity by building features of the model for the entity using data regarding the entity;
computing a diffusion model coefficient σ based on a diffusion parameter vector γ;
computing a drift model coefficient μ based on a drift parameter vector β; and
computing a predicted entity success probability and confidence interval; and
a portfolio selection module, configured to perform steps comprising:
receiving a score for the plurality of entities based on the model;
ordering the scores in a rank order the scores; and
forming a portfolio from top n scoring entities,
wherein the score comprises a measure of success for the entity,
wherein the data further comprises an entity resource data, an industry sector of the entity, entity resource data, a competing entity data, personnel data, and an estimation of missing data.

10. The system of claim 9, further comprising a prediction interpretation module configured to perform the steps of:
receiving a diffusion σ and a diffusion parameter vector γ for the model;
receiving a drift model coefficient μ and a drift parameter vector β the model;
for a plurality of features, building a distribution of β and γ for each feature;
scoring and ranking diffusion and drift scores for the entity based on the distribution; and
using the scores and ranks to correlate an entity feature corresponding to the distributions of β and γ with a success for the entity.

11. The system of claim 9, further comprising:
a web platform configured to provide model estimation features and portfolio selection results, further comprising:
an entity search and analysis interface configured to provide access to data for a plurality of entities;
a portfolio building tool; and
a user profile feature configured to track a selected entity and/or portfolio.

12. The system of claim 11, wherein the entity search and analysis interface displays entity information including one or more of the group consisting of anomalous features, a model estimate for β, a model estimate for γ, and entity funding round time information.
